(19) United States
(12) Patent Application Publication
(10) Pub. No.: US 2026/0369577 A1
(43) Pub. Date: Nov. 19, 2026

(54) METHOD OF MANUFACTURING AN ELECTRODE-ELECTROLYTE LAMINATE

(71) Applicant: Dyson Technology Limited, Malmesbury, Wiltshire (GB)

(72) Inventors: John William Alexander POULTER, Bristol (GB); Matthew Robert ROBERTS, Oxford (GB)

(21) Appl. No.: 19/133,846

(22) PCT Filed: Nov. 9, 2023
(86) PCT No.: PCT/IB2023/061318

§ 371 Date: May 29, 2025

(30) Foreign Application Priority Data
Nov. 30, 2022 (GB) 2217986.5

(51) Int. Cl. H01M 4/38; H01M 4/02; H01M 4/04; H01M 10/052; H01M 10/0562

(52) U.S. Cl. CPC H01M 4/382; H01M 4/0407; H01M 4/0426; H01M 10/052; H01M 10/0562; H01M 2004/021; H01M 2004/027; H01M 2004/028; H01M 2300/0068

(57) ABSTRACT

Disclosed is an electrode-electrolyte laminate and a method of manufacturing an electrode-electrolyte laminate, for use in a lithium-metal cell. The method includes the steps of depositing a ceramic electrolyte layer onto a first surface of a sacrificial polymer substrate, and depositing a layer of lithium metal onto an exposed surface of the ceramic electrolyte layer. The sacrificial polymer substrate is then removed to form the electrode-electrolyte laminate. The electrode-electrolyte laminate prepared by the method is useful in the manufacture of an electrochemical cell.

### FIELD OF THE INVENTION

The present invention relates to a method of manufacturing an electrode-electrolyte laminate for use in a lithium-metal cell, and electrode-electrolyte laminates manufactured by such methods.

### BACKGROUND OF THE INVENTION

Lithium-ion secondary batteries are the leading battery technology currently used in applications from small personal devices to electric vehicles. Lithium-ion batteries are favoured for their high energy density and long cycle life, among other benefits. They contain a plurality of lithium-ion secondary cells, which is one example of an alkali metal ion secondary cell.

Lithium metal anodes are attracting interest due to their high energy density compared with more conventional anodes such as graphite. However Li anodes are prone to failure, primarily under two modes: firstly, Li dendrites may grow across the cell during operation, potentially leading to short-circuit and catastrophic cell failure. Secondly, the continued consumption of electrolyte components in SEI formation can impact cycle life and cell performance.

It is known to use a protective coating on the anode surface in order to address one or more of these drawbacks. For example, U.S. Pat. No. 7,939,205 describes a layer of “hard electrolyte” covering the negative and/or positive electrode. A layer of lithium phosphorus oxynitride (LiPON) is suggested as a coating on the anode to prevent the growth of dendrites across the cell.

However the inventors have found that the coating of LiPON onto the lithium metal anode by PVD leads to the conversion of some of the lithium in the anode to Li₃N, thereby reducing the energy density of the anode. Furthermore, aggressive species within the plasma used for deposition can produce Li₂O film on the surface of the Li metal anode, further reducing anode performance.

Traditional lithium-ion battery components such as electrodes are made from a solvent cast process that uses sacrificial solvent. This is an energetically expensive step, and a process that avoids using sacrificial solvent is therefore desirable.

A further major drawback of lithium-ion technology and other alkali-metal ion secondary cell technology is that a liquid electrolyte is often used within the lithium-ion cells of the battery, to provide conductivity of lithium ions within the cell between the solid, solvent cast anode and cathode. This causes safety problems since the liquid electrolytes are often highly flammable. This is a particular problem for electric vehicles, where a collision with another vehicle may be relatively likely and the resulting impact may cause damage to the battery and ignition of the electrolyte. It is also a problem for devices used in the home, where a lithium-ion battery fire could cause damage to property or serious injury.

One approach to avoiding the use of sacrificial solvent, and the need for liquid electrolyte within the cell, is preparing gel electrodes. These electrodes can be formed from a composition prepared by mixing the necessary components such as electrochemically active material, polymer, and a liquid electrolyte, and subsequently subjecting the composition to a thermal treatment. Such gel electrodes are described in WO 2017/017023 A1, which attempts to manufacture electrochemical devices free of liquid electrolytes.

Gel electrodes are assembled together with other gel or solid-state components to form a cell, thereby reducing the risk of fire due to the removal of free liquid from the cell. The cell manufacturing costs are also reduced because the gel components can be produced by simpler processing steps without the need for slow drying of solvent needed for solvent cast electrodes.

There is a need for processes of manufacturing Li-metal cells which provide the cell with protection from dendrite growth and limit the consumption of electrolyte components, without detrimentally impacting the properties of the Li metal anode. It would also be desirable for such processes to permit the Li metal cell to also incorporate gelled components. Presently, due to the reactivity of the Li metal anode, it is necessary to use only full solid-state (ceramic) cathodes and other solvent-cast or gelled cathodes are excluded. Full solid-state cathodes and complex and expensive to manufacture. Opening up the possibility of using a solvent-cast or gelled cathode alongside a Li metal anode would provide much more flexibility in manufacture and component choice.

The present invention was developed with this in mind, and provides a manufacturing method which enables a Li-metal anode to be protected from dendrite growth while avoiding the detrimental generation of large amounts of Li₃N and Li₂O, and allowing for assembly of the anode with gelled cell components.

### SUMMARY OF THE INVENTION

The invention relates generally to methods of manufacturing an electrode-electrolyte laminate, and in particular to the sequential deposition of layers onto a sacrificial polymer substrate before removal of the sacrificial polymer substrate.

A first aspect of the invention is a method of manufacturing an electrode-electrolyte laminate for use in a lithium-metal cell, comprising:
depositing a ceramic electrolyte layer onto a first surface of a sacrificial polymer substrate;
depositing a layer of lithium metal onto an exposed surface of the ceramic electrolyte layer to form a laminate precursor; and
removing the sacrificial polymer substrate from the laminate precursor to form the electrode-electrolyte laminate.

The sequential deposition onto a sacrificial polymer substrate of ceramic electrolyte layer followed by lithium metal offers a number of advantages. Firstly, since the ceramic electrolyte layer is deposited directly onto the sacrificial polymer substrate rather than onto a lithium metal anode layer, the formation of problematic species such as Li₃N and Li₂O is avoided. The inventors found that when the ceramic electrolyte layer is deposited directly onto the Li metal anode, large amounts of Li₃N and Li₂O are formed, in some cases consuming the entire Li metal anode and rendering the cell unusable. By instead depositing the ceramic electrolyte layer directly onto a sacrificial polymer substrate, followed by the deposition of lithium metal onto the ceramic electrolyte layer, a small layer of Li₃N and Li₂O (solid electrolyte interphase) is formed spontaneously between the lithium metal layer and the ceramic electrolyte layer (typically 50-100 nm thick), which does not impair cell function and is in fact beneficial, providing an SEI layer which protects the Li metal anode from consumption or degradation during cell cycling. The so-formed SEI is stable, offering protection which lasts multiple cell cycles.

Secondly, the electrode-electrolyte laminate structure resulting from the method is easily assembled with a cathode layer, which may be either a traditional solvent-cast cathode or a gelled cathode, providing versatility. It is therefore possible to use the electrode-electrolyte laminate to manufacture a cell containing a gel cathode along with a lithium metal anode, providing all the benefits associated with gel components within a Li-metal cell.

Thirdly, the method is straightforward and efficient since the same equipment and procedure may be used to deposit both the initial ceramic electrolyte layer and the subsequent lithium metal layer, reducing the cost, complexity and environmental impact of manufacture.

Furthermore, the process provides an electrode-electrolyte laminate structure which is simply a layer of Li metal coated in a ceramic electrolyte layer. This can be combined with a cathode structure to form a cell without any need for a separator layer between the cathode and the ceramic electrolyte layer. The result is a cell with few layers, reducing the number of interfaces within the cell thereby reducing the impedance, and also increasing both the gravimetric and volumetric energy density of the device due to the reduced number of layers.

A second aspect of the invention provides an electrode-electrolyte laminate for use in a lithium-metal cell, prepared by a method according to the first aspect, comprising:
a ceramic electrolyte layer; and
a lithium metal layer on a first surface of the ceramic electrolyte layer.

A third aspect of the invention provides an electrochemical cell comprising the electrode-electrolyte laminate structure according to the second aspect.

A fourth aspect of the invention provides an electrochemical energy storage device comprising the electrochemical cell according to the third aspect.

Preferred and/or optional features of the invention will now be set out. Any aspect of the invention may be combined with any other aspect of the invention unless the context demands otherwise. Any of the preferred and/or optional features of any aspect may be combined, either singly or in combination, with any aspect of the invention unless the context demands otherwise.

### Ceramic Electrolyte Layer

In some embodiments, the ceramic electrolyte layer comprises a thin film of ceramic electrolyte material in contact with, or adhered to, the first surface of the sacrificial polymer substrate (before removal of the sacrificial polymer substrate). There may be direct contact between the ceramic electrolyte layer and the first surface of the sacrificial polymer substrate, i.e. no further material layer between the ceramic electrolyte layer and the first surface of the sacrificial polymer substrate.

In some embodiments the ceramic electrolyte layer comprises one or more of lithium phosphorus oxynitride (LiPON), lithium borosilicate (LBSO), lithium phosphate (Li₃PO₄), boron-doped lithium phosphorous oxynitride (LiBPON), lithium silicate, lithium borate, LAGP, LATP, LiSICON, lithium garnet ceramics (e.g. LLTO, LLZO, and LLZTO), and perovskites.

The ceramic electrolyte layer may comprise or consist of a solid inorganic material which conducts lithium ions. The ceramic electrolyte layer may comprise or consist of a solid ceramic material which conducts lithium ions.

In some embodiments the ceramic electrolyte layer comprises a ceramic electrolyte material which has a modulus of at least 5 GPa, for example at least 6 GPa, at least 8 GPa, or at least 10 GPa. Providing a material with this modulus ensures that dendrite growth is mitigated.

In some embodiments the ceramic electrolyte layer comprises or consists of LiPON. LiPON is a known solid Li-ion conductor of general formula LiₓPO_{y}N_{z}. LiPON can be deposited onto the sacrificial polymer substrate at very small thicknesses, for example down to around 100 nm, enabling the dimensions of the cell to be limited. Even at such thicknesses, LiPON retains its ability to prevent or reduce dendrite growth across the cell due to its amorphous and non-porous structure, meaning that there are no grain boundaries or pores through which a dendrite could grow.

In some embodiments, the ceramic electrolyte layer has an amorphous structure. An amorphous ceramic electrolyte layer lacks any grain boundaries which would be present in a crystalline layer. Since grain boundaries could in theory provide a path through which dendrites could grow, an amorphous ceramic electrolyte layer is less prone to the dendrite growth which could lead to cell failure.

In some embodiments, the ceramic electrolyte layer lacks or substantially lacks apertures extending through the plane of the layer. Such apertures are generally known as “pinholes” and may provide another way for dendrites to grow through the electrolyte layer. By ensuring the absence or substantial absence of pinholes, dendrite growth through the layer is further limited. The risk of pinhole formation can be reduced, for example, by ensuring little or no contamination of the sacrificial polymer substrate before deposition of the ceramic electrolyte (for example, ensuring no dust formation on the sacrificial polymer substrate), and by providing ceramic electrolyte deposition conditions which ensure maximum adatom diffusion over the sacrificial polymer substrate surface, such that the deposited ceramic electrolyte fills the maximum number of voids on the growing film on the substrate.

In some embodiments the ceramic electrolyte layer is deposited onto the first surface of the sacrificial polymer substrate by a deposition process which involves the gradual deposition of atoms or molecules of the ceramic electrolyte onto the first surface of the sacrificial polymer substrate. In this way, a continuous thin layer may be formed with full contact between the sacrificial polymer substrate and the ceramic electrolyte layer which would not be achievable through the mechanical placement of a pre-formed ceramic electrolyte layer onto the sacrificial polymer substrate. This ensures minimal internal resistance of the cell.

In some embodiments the ceramic electrolyte layer is deposited onto the first surface of the sacrificial polymer substrate by a vacuum deposition processes, preferably by PVD. This ensures controllable thickness of the film and reduced film contamination by conducting deposition under vacuum.

The ceramic electrolyte layer may be deposited onto the first surface of the sacrificial polymer substrate by a PVD process selected from (a) reactive sputtering, or (b) plasma-assisted reactive evaporation.

Reactive sputtering involves RF sputtering of a suitable target using a nitrogen plasma. The target may comprise a material which, when sputtered and then deposited onto the sacrificial polymer substrate, forms the ceramic material of the ceramic electrolyte layer. In embodiments where the ceramic electrolyte layer comprises or consists of LiPON, the target may comprise or consist of lithium phosphate.

Plasma-assisted reactive evaporation involves evaporating a source material in the presence of a nitrogen plasma. The evaporation may be achieved thermally or using an electron gun. The source material may comprise a material which, when sputtered and then deposited onto the sacrificial polymer substrate, forms the ceramic material of the ceramic electrolyte layer. In embodiments where the ceramic electrolyte layer comprises or consists of LiPON, the source material may comprise or consist of lithium phosphate.

Alternatively, deposition of the ceramic electrolyte layer may be achieved by atomic layer deposition (ALD) or chemical vapour deposition (CVD).

In some embodiments, after deposition the ceramic electrolyte layer has a thickness of from about 0.1 μm to about 4 μm, for example from about 0.1 μm to about 3.5 μm, from about 0.1 μm to about 3 μm, from about 0.1 μm to about 2.5 μm, or from about 0.1 μm to about 2 λm.

In some embodiments, after deposition the ceramic electrolyte layer has a thickness of from about 0.1 μm to about 1 μm, for example from about 0.1 μm to less than 1 μm.

The thickness of the ceramic electrolyte layer may be controlled by controlling the length of time for which deposition is continued during the vacuum deposition process.

In some embodiments, the ceramic electrolyte layer comprises or consists of LiPON and is deposited onto the first surface of the sacrificial polymer substrate by a PVD method comprising:
preparing a vacuum chamber with a lithium phosphate target and a sputter source;
providing a sacrificial polymer substrate within the vacuum chamber;
providing a vacuum within the vacuum chamber with a pressure of less than 0.1 Pa; and
depositing LiPON onto a first surface of the sacrificial polymer substrate by sputtering the lithium phosphate target.

The sputter source may comprise an rf magnetron.

The sacrificial polymer substrate may be tensioned on a frame within the vacuum chamber to ensure a smooth tensioned surface for even deposition.

Ensuring a vacuum of less than 0.1 Pa minimises the presence of contaminants within the chamber, thereby improving the purity of the deposited LiPON layer. In preferred embodiments, a vacuum of less than 1×10⁻⁴ Pa is provided, further reducing contaminants within the chamber and improving deposited layer purity.

In some embodiments, the step of depositing LiPON onto the surface of the sacrificial polymer substrate by sputtering the lithium phosphate target comprises the following steps:
feeding a continuous supply of nitrogen gas into the vacuum chamber;
applying an RF power supply to RF bias the lithium phosphate target;
forming a nitrogen plasma with the RF field;
sputtering the lithium phosphate target by bombardment with the nitrogen plasma to eject material from the lithium phosphate target into the vacuum chamber; and
condensing material onto the surface of the sacrificial polymer substrate to form the LiPON layer.

In some embodiments, the continuous feed of nitrogen gas is such that the pressure in the vacuum chamber rises to a pressure within the range 0.1 to 1.0 Pa.

### Lithium Metal Layer

The method of the first aspect comprises depositing a layer of lithium metal onto an exposed surface of the ceramic electrolyte layer to form a laminate precursor.

The layer of lithium metal is deposited onto an exposed surface of the ceramic electrolyte layer. In other words, after deposition of both the ceramic electrolyte layer and the lithium metal layer, the laminate precursor comprises, in sequence, the sacrificial polymer substrate, the ceramic electrolyte layer and the lithium metal layer. The ceramic electrolyte layer is therefore sandwiched between the sacrificial polymer substrate and the lithium metal layer.

The term “laminate precursor” refers to the laminate structure comprising the sacrificial polymer substrate, the ceramic electrolyte layer and the lithium metal layer, before removal of the sacrificial polymer substrate. This structure is a precursor to the final electrode-electrolyte laminate which is produced by removing the sacrificial polymer substrate layer from the precursor.

In some embodiments, after deposition of the lithium metal layer there is no material layer between the ceramic electrolyte layer and the lithium metal layer.

The lithium metal layer comprises or consists of metallic lithium.

In some embodiments, the ceramic electrolyte layer and the lithium metal layer are deposited by the deposition techniques which involve the gradual deposition of atoms or molecules of material onto the surface of a substrate, under vacuum conditions. This simplifies the process, allowing similar methods and equipment to be used for the two deposition steps, reducing the overall manufacturing cost and eliminating the need to remove the sacrificial polymer substrate from a vacuum chamber between deposition steps. In some embodiments, the ceramic electrolyte layer and the lithium metal layer are each deposited by a PVD-type technique. For example, the ceramic electrolyte layer may be deposited by sputtering and the lithium metal layer may be deposited by thermal evaporation, both of which are examples of PVD methods.

In some embodiments, after the deposition of the ceramic electrolyte layer, the sacrificial polymer substrate may be moved (for example, rotated or translated) within the vacuum chamber to facilitate the subsequent deposition of the lithium metal layer.

In some embodiments, a pre-formed thin film of lithium metal is deposited onto the ceramic electrolyte layer. However such methods are less preferred, because the resultant contact between the ceramic electrolyte layer and the lithium metal layer would be incomplete, leading to variations in current density across the cell which could eventually lead to cell failure. Such methods may also lead to a higher risk of introducing contaminants due to the need to manually manipulate the lithium metal layer. This could also damage the ceramic electrolyte and lithium metal layers.

In some embodiments, the layer of lithium metal is deposited onto the exposed surface of the ceramic electrolyte layer by a deposition process which involves the gradual deposition of lithium atoms onto the ceramic electrolyte layer. In this way, a continuous thin layer may be formed with full contact between the ceramic electrolyte layer and the lithium metal layer, which would not be achievable through the mechanical placement of a pre-formed lithium metal layer onto the ceramic electrolyte layer. This ensures minimal internal resistance of the cell.

In some embodiments the layer of lithium metal is deposited onto the exposed surface of the ceramic electrolyte layer by a vacuum deposition processes, preferably by PVD. This ensures controllable thickness of the film and reduced film contamination by conducting deposition under vacuum.

In some embodiments the ceramic electrolyte layer and the lithium metal layer are sequentially deposited by PVD. In some embodiments the ceramic electrolyte layer and the lithium metal layer are sequentially deposited by PVD without removing the sacrificial polymer substrate from the vacuum chamber and without venting the vacuum chamber between the deposition steps.

In some embodiments, after deposition the lithium metal layer has a thickness of from about 0.01 μm to about 15 μm, for example from about 0.1 μm to about 15 μm, from about 0.1 μm to about 10 μm, from about 0.1 μm to about 5 μm, or from about 0.1 μm to about 2 μm.

In some embodiments, the lithium metal layer is very thin, for example from about 0.01 μm to about 1 μm thick or from about 0.01 μm to about 0.1 μm thick. Such thicknesses are possible because the lithium metal need not provide structural support to the laminate (which is instead provided by the ceramic electrolyte layer). Such a thin lithium metal layer acts as a useful seed layer for subsequent lithium plating during charging of the cell, while maintaining a high volumetric and gravimetric energy density.

The thickness of the lithium metal layer may be controlled by controlling the length of time for which deposition is continued during the vacuum deposition process.

In some embodiments, vacuum conditions are maintained between the deposition of the ceramic electrolyte layer and the deposition of the lithium metal. This provides a simple and efficient process, removing the need to vent the vacuum chamber or re-establish a vacuum for Li metal deposition.

In some embodiments the lithium metal layer is deposited by thermal evaporation.

In some embodiments, the method comprises providing a thermal evaporation source comprising lithium metal. The thermal evaporation source may comprise a resistively heatable crucible containing lithium metal which is heated to vaporise the lithium.

In some embodiments, the method comprises heating lithium metal under vacuum to a temperature of greater than 250 °C to form Li vapour, for example greater than 300 °C, greater than 350 °C or greater than 400 °C, and depositing Li onto the exposed surface of the ceramic electrolyte layer from the vapour by condensation. Higher temperatures over 300 °C are preferred, because below this the vapour pressure of lithium may be too low for efficient vaporisation and deposition.

At temperatures of greater than 250 °C, for example greater than 300 °C, greater than 350 °C or greater than 400 °C, when under a vacuum of around 1×10⁻⁶ mbar, molten lithium begins to vaporise and the resultant Li vapour will then condense onto the surface of the ceramic electrolyte layer which has previously been deposited onto the sacrificial polymer substrate, to form a Li metal layer on the ceramic electrolyte layer.

In some embodiments, the Li metal is heated using resistive heating. The heating may be performed in a suitable crucible.

In some embodiments, the lithium metal layer is deposited onto the exposed surface of the ceramic electrolyte layer by a PVD method comprising:
preparing a vacuum chamber with a thermal evaporation source comprising lithium metal;
providing a substrate comprising a layer of ceramic electrolyte deposited onto a sacrificial polymer substrate within the vacuum chamber;
providing a vacuum within the vacuum chamber with a pressure of less than 1×10⁻⁶ mbar; and
depositing lithium metal onto the surface of the ceramic electrolyte layer by vaporising lithium from the thermal evaporation source and condensing lithium onto the ceramic electrolyte layer.

Ensuring a vacuum of less than 1×10⁻⁶ mbar minimises the presence of contaminants within the chamber, thereby improving the purity of the deposited Li layer.

In some embodiments, the method of manufacturing the electrode-electrolyte laminate comprises:
depositing a LiPON layer onto a first surface of a sacrificial polymer substrate; and
depositing a layer of lithium metal onto an exposed surface of the LiPON layer.

In some embodiments, the method of manufacturing the electrode-electrolyte laminate comprises:
depositing a LiPON layer onto a first surface of a sacrificial polymer substrate comprising or consisting of polystyrene (PS); and
depositing a layer of lithium metal onto an exposed surface of the LiPON layer;

wherein both the deposition of the LiPON layer and the deposition of the layer of lithium metal are achieved by PVD.

In some embodiments, the method of manufacturing the electrode-electrolyte laminate comprises:
preparing a vacuum chamber containing a lithium phosphate target, a sputter source and a thermal evaporation source comprising lithium;
providing a sacrificial polymer substrate within the vacuum chamber;
providing a vacuum within the vacuum chamber with a pressure of less than 1×10⁻⁶ mbar;
depositing LiPON onto the surface of the sacrificial polymer substrate by sputtering the lithium phosphate target, to form a LiPON layer on the surface of the sacrificial polymer substrate;
stopping the deposition of LiPON after a desired thickness of lipon layer has been achieved;
maintaining vacuum conditions within the vacuum chamber;
depositing lithium metal onto the surface of the LiPON layer by vaporising lithium from the thermal evaporation source and condensing lithium onto the LiPON layer; and
stopping the deposition of lithium metal after a desired thickness of lithium metal layer has been achieved.

### Sacrificial Polymer Substrate

The method of the fist aspect comprises removing the sacrificial polymer substrate from the laminate precursor to form the electrode-electrolyte laminate.

In some embodiments, the sacrificial polymer substrate comprises one or more sacrificial polymers. The term “sacrificial polymer” herein refers to a polymer which is able to be removed from the laminate precursor by dissolution into a solvent without any degradation of the ceramic electrolyte or lithium metal layers of the laminate precursor.

The sacrificial polymer substrate may comprise one or more sacrificial polymers independently selected from poly(ethyleneglycol dimethacrylate), poly(ethyleneglycol diacrylate), poly(propyleneglycol dimethacrylate), poly(propyleneglycol diacrylate), poly(methyl methacrylate) (PMMA), poly(acrylonitrile) (PAN), polyurethane (PU), poly(vinylidene difluoride) (PVdF), poly(vinylidene fluoride-co-hexafluoropropylene) (PvDF-HFP), poly(ethylene oxide) (PEO), poly-L-lactic acid (PLA), polystyrene (PS), poly(ethyleneglycol dimethylether), poly(ethyleneglycol diethylether), poly[bis(methoxy ethoxyethoxide)-phosphazene], poly(dimethylsiloxane) (PDMS), polyacene, polydisulfide, polystyrene, polystyrene sulfonate, polypyrrole, polyaniline, polythiophene, polythione, polyvinyl pyridine (PVP), polyvinyl chloride (PVC), polyaniline, poly(3,4-ethylenedioxythiophene) (PEDOT), poly(p-phenylene), poly(triphenylene), polyazulene, polyfluorene, polynaphthalene, polyanthracene, polyfuran, polycarbazole, tetrathiafulvalene-substituted polystyrene, ferrocene-substituted polyethylene, carbazole-substituted polyethylene, polyoxyphenazine, poly(heteroacene), poly[(4-styrenesulfonyl)(trifluoromethanesulfonyl)imide-co-methoxy-polyethyleneglycolacrylate] (Li[PSTFSI-co-MPEGA]), sulfonated poly(phenylene oxide) (PPO), N, N-dimethylacryl amide (DMAAm), lithium 2-acrylamido-2-methyl-1-propane sulfonate (LiAMPS), Poly(lithium 2-Acrylamido-2-Methylpropanesulfonic Acid-Co-Vinyl Triethoxysilane), polyethyleneoxide(PEO)/poly(lithium sorbate), PEO/poly(lithium muconate), PEO/[poly(lithium sorbate)+BF₃], PEO copolymer, PEO terpolymer, and NIPPON SHOKUBAI® polymer.

The sacrificial polymer substrate may comprise one or more sacrificial polymers independently selected from poly(vinylidene difluoride) (PVdF), poly(methyl methacrylate) (PMMA), poly(ethylene oxide) (PEO), poly-L-lactic acid (PLA) and polystyrene (PS). In some embodiments, the sacrificial polymer substrate comprises or consists of a single sacrificial polymer selected from poly(vinylidene difluoride) (PVdF), poly(methyl methacrylate) (PMMA), poly(ethylene oxide) (PEO), poly-L-lactic acid (PLA) and polystyrene (PS). In some embodiments, the sacrificial polymer substrate comprises or consists of poly(vinylidene difluoride) (PVdF), poly-L-lactic acid (PLA) and polystyrene (PS). In some embodiments, the sacrificial polymer substrate comprises or consists of polystyrene (PS).

A sacrificial polymer substrate comprising or consisting of PS provides a robust structure which is easy to handle. Mechanically stable PS films are possible at very small thicknesses, such as below 10 μm thick, making it much easier to remove the thin sacrificial polymer substrate from the laminate precursor by dissolution in solvent, to form the electrode-electrolyte laminate. It is also possible to dissolve PVdF, PLA or PS in solvents which do not cause any degradation of the ceramic electrolyte or lithium metal layers of the laminate precursor, such as linear or cyclic carbonate solvents.

In some embodiments, the sacrificial polymer substrate lacks or substantially lacks apertures extending through the plane of the sacrificial polymer substrate. Such apertures are generally known as “pinholes”. If such pinholes are present in the sacrificial polymer substrate, then corresponding pinholes are likely to also be present in the deposited ceramic electrolyte layer. The risk of pinhole formation can be reduced, for example, by ensuring the formation of a dense polymer material during preparation of the sacrificial polymer substrate, e.g. by extrusion of the polymer into a film or by tape-casting a slurry of polymer powder to form the sacrificial polymer substrate. The choice of polymer can also help reduce the risk of pinhole formation. The inventors have found that PS or PvDF-HFP are particularly suitable polymer for forming defect-free sacrificial polymer substrates with little or no pinhole formation.

In some embodiments, the sacrificial polymer substrate has a porosity of less than 2%, for example less than 1%, less than 0.5%, less than 0.1% or less than 0.01%. In some embodiments, the sacrificial polymer substrate is 100% dense, i.e. 0% porous. The presence of porosity is undesirable, since it leads to difficulties in forming a conformal film of ceramic electrolyte on the sacrificial polymer substrate.

In some embodiments, the sacrificial polymer substrate has the ability to support its own weight, i.e. the sacrificial polymer substrate is freestanding. This allows it to be tensioned within the vacuum chamber for deposition of the ceramic electrolyte layer.

In some embodiments, the polymer used for the sacrificial polymer substrate has a melting point such that it does not melt under the heat of deposition of the ceramic electrolyte layer. The skilled person is able to choose a suitable polymer and tailor the deposition conditions to ensure that this is the case.

The thickness of the sacrificial polymer substrate may also influence its ease of dissolution and removal. A thinner substrate may be expected to be dissolved and removed more easily, with a lower chance of residual polymer deposits on the ceramic electrolyte layer afterwards. However the substrate should also be thick enough to have a robust structure and facilitate coating with the ceramic electrolyte layer. In some embodiments, the sacrificial polymer substrate has a thickness of from about 2 μm to about 100 μm, for example from about 2 μm to about 50 μm, for example from about 5 μm to about 100 μm, for example from about 5 μm to about 40 μm, for example from about 2 μm to about 10 μm.

In some embodiments, the sacrificial polymer substrate is removed by dissolving the sacrificial polymer substrate in a solvent.

In some embodiments, the solvent comprises or consists of one or more linear or cyclic carbonate compounds. The solvent may comprise or consist of one or more of dimethyl carbonate (DMC), ethyl methyl carbonate (EMC) and acetone. In some embodiments, the solvent comprises or consists of DMC.

In some embodiments, the sacrificial polymer substrate is soaked in solvent, followed by a step of rinsing to remove any residual sacrificial polymer substrate. The soaking in solvent may be carried out for at least 30 mins, for example at least 45 mins or at least 1 hour. A longer soaking time may help to ensure more complete dissolution and removal of the polymer.

The soaking in solvent may be carried out either with or without stirring.

During soaking, in some embodiments the solvent is maintained at a temperature of from 10 °C to 30 °C, for example from 15 °C to 25 °C, or at room temperature.

In some embodiments, a higher temperature of solvent may be preferred in order to reduce the time required to remove the sacrificial polymer substrate and/or ensure more complete dissolution and removal of residual polymer. During soaking, in some embodiments the solvent is maintained at a temperature of from 25 °C to 60 °C, for example from 30 °C to 60 °C.

### Passivating Interphase Layer

In some embodiments, the method further comprises the formation of a passivating interphase layer between the ceramic electrolyte layer and the lithium metal layer.

Such a layer may develop spontaneously depending on the method of deposition of lithium metal onto the ceramic electrolyte layer.

In some embodiments, the passivating interphase layer between the ceramic electrolyte layer and the lithium metal layer comprises or consists of Li₃PO₄, Li₃N and LiO₂.

The passivating layer provides a stable SEI which protects the lithium metal anode layer. It functions to limit the consumption or degradation of lithium from the lithium anode during cycling of the cell.

The amount of Li₃N in the passivating layer is much lower than would arise from the deposition of LiPON onto a lithium metal anode by PVD. This is because PVD of LiPON onto a lithium metal anode requires the feeding of nitrogen gas into the system during deposition, resulting in high levels of Li₃N formed at the lithium anode surface. By contrast, the present method first forms a layer of ceramic electrolyte (e.g. LiPON) on the sacrificial polymer substrate, before depositing lithium metal using thermal evaporation which does not require nitrogen. The passivating layer forms purely from the reaction between the LiPON layer and the lithium metal layer after deposition. The amount of Li₃N at the layer interface is therefore minimised and the performance of the cell is not detrimentally affected.

Encapsulation layer

In some embodiments, the method of the invention further comprises the step of providing a protective encapsulation layer on the exposed surface of the layer of lithium metal. This encapsulation layer may be deposited before the step of removing the sacrificial polymer substrate from the laminate precursor. In this way, a laminate precursor is formed comprising the following layers, in sequence: sacrificial polymer substrate, ceramic electrolyte, lithium metal, encapsulation.

The protective encapsulation layer may protect the lithium metal layer from reaction with the air. This helps to maintain the purity of the lithium metal layer between manufacture of the electrode-electrolyte laminate and its incorporation into a cell, thereby improving the performance of the cell.

In some embodiments, the encapsulation layer is deposited onto the exposed surface of the lithium metal layer by a deposition process which involves the gradual deposition of atoms or molecules onto the lithium metal layer.

In some embodiments the encapsulation layer is deposited onto the exposed surface of the lithium metal layer by a vacuum deposition process, preferably by PVD. This ensures controllable thickness of the film and reduced film contamination by conducting deposition under vacuum.

Alternatively, deposition of the encapsulation layer may be achieved by atomic layer deposition (ALD) or chemical vapour deposition (CVD).

In some embodiments the ceramic electrolyte layer, the lithium metal layer and the encapsulation layer are sequentially deposited by PVD. In some embodiments the lithium metal layer and the encapsulation layer are sequentially deposited by PVD without removing the substrate from the vacuum chamber and without venting the vacuum chamber between the deposition steps. In some embodiments the ceramic electrolyte layer, the lithium metal layer and the encapsulation layer are sequentially deposited by PVD without removing the substrate from the vacuum chamber and without venting the vacuum chamber between the deposition steps. This ensures little or no contamination of the laminate as layers are built up, and provides a more efficient and lower-cost process due to minimal equipment use and no need for the reestablishment of a vacuum during manufacture.

Alternatively, the encapsulation layer may be deposited after the step of removing the sacrificial polymer substrate from the laminate precursor, thereby providing an electrode-electrolyte laminate comprising the following layers, in sequence: ceramic electrolyte, lithium metal, encapsulation.

In some embodiments, the encapsulation layer completely covers all exposed surfaces of the layer of lithium metal. In other words, the encapsulation layer may cover both the exposed upper (planar) surface of the layer of lithium metal and also all edges of the layer of lithium metal, such that the encapsulation layer makes contact with the ceramic electrolyte layer around the periphery of the lithium metal layer. In this way, no lithium metal remains exposed to the external atmosphere and contamination of the lithium metal is minimised.

The skilled person is aware of materials suitable to be deposited onto the lithium metal layer as an encapsulation layer. The encapsulation layer will have chemical and electrochemical stability with respect to lithium metal, will be impermeable or substantially impermeable to air (to protect the lithium from reaction with air), and in some embodiments is sufficiently thin to not be detrimental to the volumetric and gravimetric energy density of the cell.

In some embodiments, the encapsulation layer is a metallic encapsulation layer. In some embodiments, the encapsulation layer is an electrically conducting metallic encapsulation layer. In this way, the lithium metal layer is encapsulated while preserving the ability to make an electrical connection with the lithium through the electrically conducting metallic encapsulation layer. In some embodiments, the encapsulation layer is a metallic encapsulation layer comprising or consisting of one or more metal elements selected from Cu, W, Mo and any other metal element which is chemically and electrochemically stable with respect to lithium metal. In some embodiments, the encapsulation layer is a metallic encapsulation layer comprising or consisting of one or more metal elements selected from Cu, W and Mo.

In some embodiments, the encapsulation layer is a polymeric encapsulation layer or a ceramic encapsulation layer. However this is less preferred to a metallic encapsulation layer, since the electrical conductivity of a polymer or ceramic is generally lower than a metallic layer, making it more difficult to ensure that an electrical connection can be made with the lithium anode. In some embodiments, the encapsulation layer is an electrically conducting polymeric encapsulation layer or an electrically conducting ceramic encapsulation layer.

In some embodiments, the encapsulation layer is not removed from the lithium metal layer before assembly of the cell, such that the finished cell comprises the encapsulation layer between the lithium metal layer and an anode current collector layer.

### Optional Polymer Separator Layer

In some embodiments the method comprises placing the surface of the ceramic electrolyte layer which is exposed by removal of the sacrificial polymer substrate into contact with a polymer separator layer, before introducing any cathode layer. The result is an electrode-electrolyte laminate comprising the following layers, in order: polymer separator, ceramic electrolyte, lithium metal, optional encapsulation. The method may then further comprise placing the surface of the polymer separator layer which is not in contact with the ceramic electrolyte layer into contact with a cathode layer. The result is an electrode-electrolyte laminate comprising the following layers, in order: cathode, polymer separator, ceramic electrolyte, lithium metal, optional encapsulation.

The polymer separator layer between the cathode and ceramic electrolyte is optional. Its presence will reduce the gravimetric and volumetric energy density of the cell, but may nevertheless be desirable in some circumstances. For example, the surface of a solvent-cast cathode may not conform well to the surface of the ceramic electrolyte layer; the surface of the solvent-cast cathode would be expected to be relatively “rough” while the surface of the ceramic electrolyte layer would be “smooth” by comparison. As a result, relatively high resistance may occur at the interface between the solvent-cast cathode and the ceramic electrolyte layer. Introducing an intermediate polymer separator may reduce the overall interfacial resistance and impedance of the cell.

The polymer separator may be made of a polymer which, when exposed to a suitable amount of liquid electrolyte, swells to form a gel matrix comprising gelled polymer and absorbed liquid electrolyte.

The polymer separator may be “dry”, i.e. non-gelled when added to the laminate, then later subjected to a gelling procedure after the laminate has been manufactured. This could be achieved by soaking the finished laminate structure in liquid electrolyte.

Thus in some embodiments, the method comprises adding a liquid electrolyte to the polymer separator to gel the polymer separator after assembly of the laminate.

The liquid electrolyte could be added to the polymer separator either before, during or after assembly of a cell or battery.

To add the liquid electrolyte before assembly of the cell, the laminate may be first soaked in liquid electrolyte to gel the polymer separator, before laminating with a cathode layer to form a cell and then either stacking or rolling multiple cells together to form a battery.

To add the liquid electrolyte during assembly of the cell, liquid electrolyte may be injected between the polymer separator and cathode layers as these two layers are brought together during assembly. The polymer separator thereby gels as the cell is formed and multiple cells can then be stacked or rolled together to form a battery.

To add the liquid electrolyte after assembly of the cell, the laminate may be laminated with a cathode layer to form a cell before adding liquid electrolyte to the polymer separator and allowing the liquid electrolyte to diffuse laterally through the polymer separator to gel the polymer separator; and then either stacking or rolling multiple cells together to form a battery.

The polymer separator may be manufactured by methods known to the skilled person. In some embodiments, the polymer separator is made by taking commercially available powdered form of the desired polymer, forming a slurry of the powder in a suitable solvent and tape casting the slurry to form the separator. Alternatively, the polymer may be extruded to form the polymer separator.

In some embodiments the second surface of the polymer separator is not coated with any layer of ceramic electrolyte between the polymer separator and the cathode layer.

In some embodiments, the cathode layer comprises liquid electrolyte which combines with the polymer separator to form a gel when the cathode layer is brought into contact with the polymer separator. In other words, the polymer separator is “dry” and gelation occurs due to contact between the “dry” polymer separator layer of the laminate and a “wet” cathode layer. This allows gelation to occur simultaneously with the assembly of the cell without the need for any separate step of adding or injecting liquid electrolyte.

Cathode layer

In some embodiments the method further comprises placing the surface of the ceramic electrolyte layer which is exposed by removal of the sacrificial polymer substrate into contact with a cathode layer. In other words, one surface of the ceramic electrolyte layer is in contact with the lithium metal layer and the remaining surface is placed into contact with a cathode layer. After assembly with the cathode layer, the ceramic electrolyte layer is therefore sandwiched between the cathode layer and the lithium metal layer.

In some embodiments, when the optional polymer separator layer is present, the method further comprises placing the surface of the polymer separator layer which is not in contact with the ceramic electrolyte layer into contact with a cathode layer. In other words, one surface of the polymer separator is in contact with the ceramic electrolyte layer and the remaining surface is placed into contact with a cathode layer. After assembly with the cathode layer, the polymer separator layer is therefore sandwiched between the cathode layer and the ceramic electrolyte layer.

In some embodiments the cathode layer comprises a gel cathode or a solvent-cast cathode.

The ceramic electrolyte (e.g. LiPON) layer acts as a barrier between the “dry” lithium metal anode and the “wet” components of the cell, i.e. the cathode layer (and optional polymer separator layer). This provides a cell which carries the benefits associated with lithium metal anode (e.g. high energy density) and gelled components (e.g. increased operational safety and high ionic conductivity).

The cathode layer may be a “conventional” solvent-cast cathode. Such a cathode comprises a positive active material and may also comprise one or more of a binder, liquid electrolyte and a conductive additive. Such cathodes are made by preparing a slurry of the above-mentioned components in a solvent and casting the solvent onto a current collector, before drying and optionally calendaring to increase the density of the electrode.

Alternatively the cathode may be a gel cathode. The gel cathode may comprise a polymer-electrolyte gel matrix phase and a dispersed phase comprising a positive active material. The dispersed phase may further comprise a conductive additive. The polymer-electrolyte gel matrix phase comprises a gel comprising a polymer and absorbed liquid electrolyte. The polymer may be selected from one or more of the polymers listed above as options for the sacrificial polymer substrate. In some embodiments, the liquid electrolyte comprises or consists of a solvent comprising one or more cyclic or linear carbonate compounds. In some embodiments the solvent comprises one or more cyclic carbonate compounds. In some embodiments the solvent comprises one or more of ethylene carbonate, propylene carbonate, dimethyl carbonate, diethyl carbonate, ethyl-methyl carbonate, butylene carbonate, vinylene carbonate, fluoroethylene carbonate, fluoropropylene carbonate and y-butyrolactone. In some embodiments, the liquid electrolyte further comprises a lithium salt. Examples of suitable lithium salts include LiPF₆, LiBF₄ and lithium bis(trifluoromethanesulfonyl)imide (LiTFSI).

### Electrode-Electrolyte Laminate

A second aspect of the invention is an electrode-electrolyte laminate for use in a lithium-metal cell, prepared by a method according to the first aspect, comprising:
a ceramic electrolyte layer; and
a lithium metal layer on a first surface of the ceramic electrolyte layer.

In some embodiments, the electrode-electrolyte laminate comprises an encapsulation layer on the surface of the lithium metal layer. In other words, the electrode-electrolyte laminate may comprise the following layers, in sequence: ceramic electrolyte, lithium metal, encapsulation layer.

In some embodiments, the electrode-electrolyte laminate does not comprise a current collector in contact with the lithium metal layer. Other methods of manufacturing laminates which rely on the deposition of lithium metal on a current collector would inevitably lead to a laminate in which lithium metal is in contact with a current collector, for example a copper foil. Since the present method builds the laminate from the sacrificial polymer substrate which is subsequently removed, the initial laminate does not contain a current collector and is able to be contacted with a current collector later during assembly of a cell.

In some embodiments the electrode-electrolyte laminate comprises a cathode layer in contact with the second surface of the ceramic electrolyte layer.

In some embodiments the electrode-electrolyte laminate comprises a polymer separator between the cathode layer and the ceramic electrolyte layer.

In some embodiments, the cathode layer comprises a gel cathode or a solvent-cast cathode. In some embodiments the electrode-electrolyte laminate comprises a polymer separator between a solvent-cast cathode layer and the ceramic electrolyte layer.

In some embodiments, when present, one surface of the polymer separator is not coated with any layer of ceramic electrolyte between the polymer separator and the cathode layer. In some embodiments, the ceramic electrolyte layer comprises or consists of LiPON.

In some embodiments, the ceramic electrolyte layer has an amorphous structure.

In some embodiments, the polymer separator, when present, comprises one or more gelling polymers independently selected from poly(vinylidene difluoride) (PVdF), poly(methyl methacrylate) (PMMA), poly(ethylene oxide) (PEO), poly-L-lactic acid (PLA) and polystyrene (PS).

A third aspect of the invention is an electrochemical cell comprising the electrode-electrolyte laminate structure according to the second aspect.

A fourth aspect of the invention is an electrochemical energy storage device comprising the electrochemical cell according to the third aspect.

### BRIEF DESCRIPTION OF THE DRAWINGS

FIG. 1 schematically illustrates a method of manufacturing an electrode-electrolyte laminate product.

FIG. 2 schematically illustrates a method of building a cell from an electrode-electrolyte laminate product.

FIG. 3 schematically illustrates an electrode-electrolyte laminate built from the anode current collector in accordance with a prior art method.

FIG. 4 schematically illustrates an electrode-electrolyte laminate built from the sacrificial polymer substrate, according to the method of the invention.

### EXAMPLES

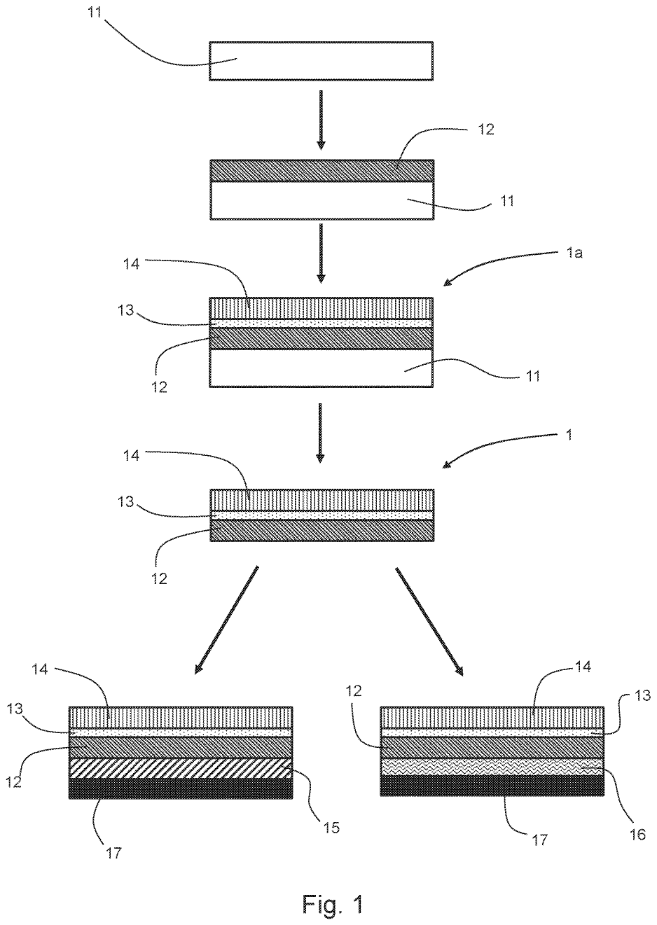

FIG. 1 is a schematic illustration of a method of manufacturing an electrode-electrolyte laminate 1 according to the invention, along with further downstream processing steps.

The sequential deposition of LiPON, lithium metal (anode layer) and tungsten metal (encapsulation layer) is done in the same small-scale modular deposition system with a vacuum chamber attached to argon and nitrogen gas bottles.

The vacuum chamber (not shown) is first prepared including two separate deposition sources: an RF magnetron sputter source with a lithium phosphate target (5.08 cm diameter); and a thermal evaporation source made up of a resistively heatable crucible containing Li metal.

A polystyrene (PS) sacrificial polymer substrate 11 is tensioned on a frame and loaded into the vacuum chamber, positioned directly above the deposition sources. The vacuum chamber is pumped down to 1×10⁻⁴ Pa.

A layer of LiPON 12 is then deposited by the following method. Firstly, a continuous supply of N₂/Ar gas mixture (Ar flow 16 sccm; N₂ flow 30 sccm) is fed into the vacuum chamber, bringing the chamber pressure to 0.15 Pa. An RF power supply (145 W) is then used to RF bias the lithium phosphate target in the RF magnetron sputter source. The sacrificial polymer substrate is 9.5 cm from the sputter gun. The sacrificial polymer substrate is rotated at 20 RPM during LiPON deposition. Resultant sputtering of material from the target causes condensation of the LiPON layer 12. A 500 nm thick layer of LiPON is deposited over a 10 hour period. The RF power supply and supply of gas are then turned off, but the vacuum within the vacuum chamber is maintained.

A layer of lithium metal 13 is then deposited by the following method. The crucible containing lithium metal is resistively heated to around 400 °C at 1×10⁻⁴ Pa pressure to first melt and then vaporise Li. The lithium source is positioned 21 cm away from the substrate. The substrate is rotated at 20 RPM during Li deposition. The Li vapour condenses onto the LiPON layer 12 to form the Li layer 13. A 10 μm thick layer of lithium is deposited over a 2 hour period.

A tungsten encapsulation layer 14 is then deposited onto the surface of the lithium metal layer 13 to protect the lithium metal from reaction with air, which would occur once the vacuum chamber is vented. In the same vacuum chamber which was used for LiPON and Li deposition, and without breaking vacuum between the depositions, W is deposited directly onto the lithium metal layer using RF magnetron sputtering (200 W RF power). A 60 sccm flow of argon gas is used (0.2 Pa working pressure) is used and the lithium metal substrate is positioned 13.5 cm from the sputter gun. The substrate is rotated at 20 RPM during W deposition. Sputtering is continued until a 100 nm thick film of tungsten is formed on the substrate.

After deposition of the encapsulation layer, the vacuum chamber is vented to atmospheric pressure and the laminate precursor 1a, still including the sacrificial polymer substrate, is removed from the chamber.

The sacrificial polymer substrate is then removed from the laminate precursor 1a to form the electrode-electrolyte laminate 1. Removal of the sacrificial polymer substrate is achieved by soaking the laminate precursor 1a in DMC solvent for 1 hour, followed by a step of rinsing the laminate to remove any residual deposits of polymer which were not fully dissolved by the soaking step.

The resultant laminate 1 can then be combined directly with different types of cathode layer. In one embodiment, a solvent-cast cathode layer 15 is cast onto a current collector layer 17 by preparing a slurry of cathode active material and optional additives in a solvent, casting the slurry onto a current collector substrate and allowing the solvent to evaporate. After an optional calendaring step, the laminate of cathode layer 15 on current collector 17 is brought into contact with the layer of LiPON 12 of the laminate 1, creating a cell structure.

Alternatively, a gel electrode layer 16 on a current collector layer 17 is brought into contact with the layer of LiPON 12 of the laminate 1, by contacting the gel electrode layer 16 with the layer of LiPON 12, creating a cell structure. The gel electrode layer contains a gelling polymer, which may be gelled by the introduction of a liquid either before, after or during the process of contacting the gel electrode layer 16 with the layer of LiPON 12. One example of a suitable liquid is an electrolyte comprising dimethyl carbonate (DMC) and one or more lithium salts.

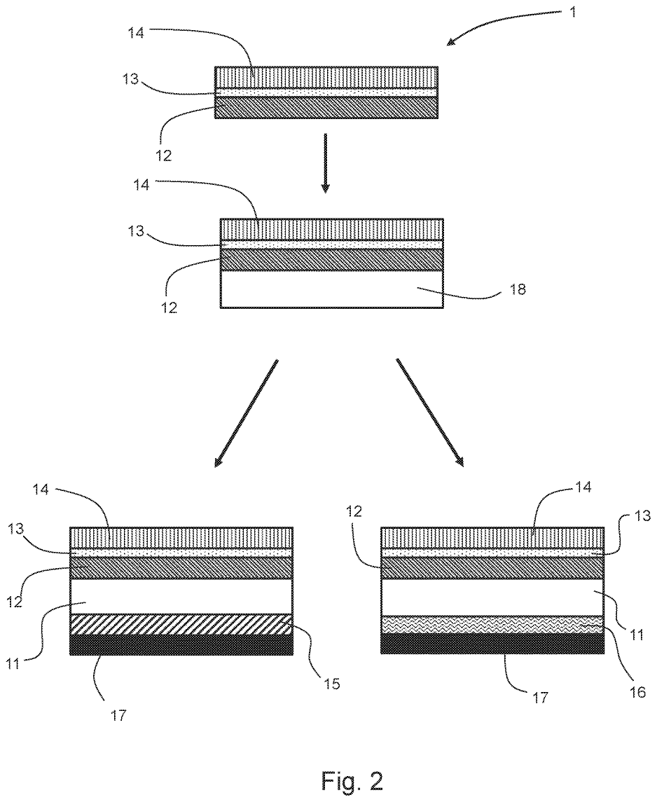

FIG. 2 shows an alternative process for manufacturing a cell from the laminate 1 which first involves adding a polymer separator layer. A polymer separator layer 18 is laminated onto the layer of LiPON 12 after removal of the sacrificial polymer substrate 11.

Then, in one embodiment, a solvent-cast cathode layer 15 is cast onto a current collector layer 17 by preparing a slurry of cathode active material and optional additives in a solvent, casting the slurry onto a current collector substrate and allowing the solvent to evaporate. After an optional calendaring step, the laminate of cathode layer 15 on current collector 17 is brought into contact with the polymer separator layer 18, creating a cell structure. A lower impedance interface may be created by including the polymer separator layer 18.

Alternatively, a gel electrode layer 16 on a current collector layer 17 is brought into contact with the polymer separator layer 18, by contacting the gel electrode layer 16 with the polymer separator layer 18, creating a cell structure. The gel electrode layer contains a gelling polymer, which may be gelled by the introduction of a liquid either before, after or during the process of contacting the gel electrode layer 16 with the polymer separator layer 18. One example of a suitable liquid is an electrolyte comprising dimethyl carbonate (DMC) and one or more lithium salts. The liquid which is used to gel the cathode later 16 will also cause the gelation of the polymer separator layer 18.

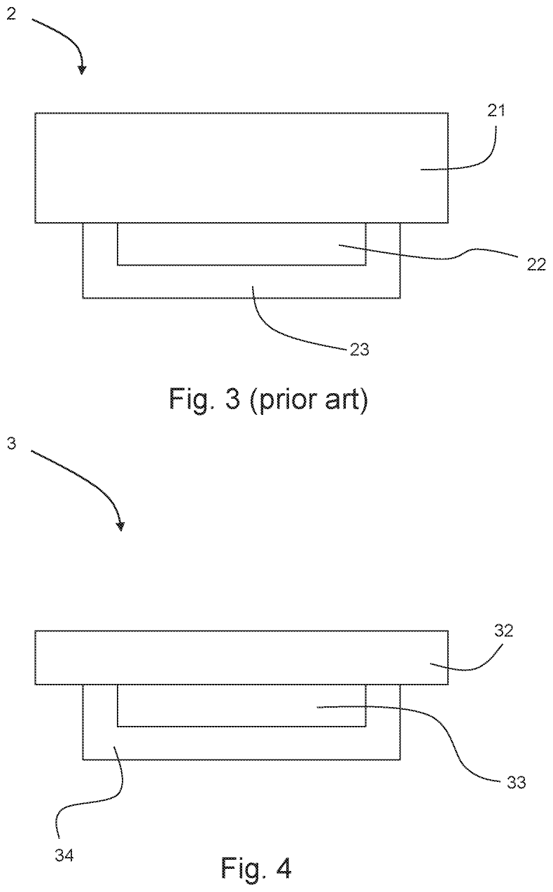

FIG. 3 shows a schematic representation of a laminate formed by a method of the prior art in which a LiPON layer is deposited onto a lithium metal anode. An anode current collector layer 21 carries a lithium metal anode layer 22. After the deposition of LiPON onto the lithium metal, a LiPON layer 23 is formed which encapsulates the lithium metal layer. It is expected that high levels of contaminants such as Li₃N and Li₂O at the interface between the lithium metal and the LiPON.

FIG. 4 shows a schematic representation of a laminate formed by a method of the invention in which a LiPON layer is deposited onto a sacrificial polymer substrate, before removal of the sacrificial polymer substrate. A layer of LiPON 32 carries a layer of lithium metal which acts as a lithium metal anode layer 33. Finally, an encapsulation layer 34 is formed which fully encapsulates the lithium metal layer 33, thereby protecting it from reaction with the air.

### Example 1—Li ion Shuttling Within Half-Cell

A PS polymer substrate was coated first with LiPON and then with Li according to the method described above to form a PS/LiPON/Li stack. The PS separator was 29 μm thick, the LiPON layer was 500 nm thick, the Li metal layer was 10 μm thick and the W encapsulation layer was 100 nm thick.

The PS layer was then removed by soaking the stack in DMC solvent for 1 hour, without any stirring, followed by rinsing with DMC to remove residual PS.

SEM-EDS showed that a bare LiPON surface is revealed by the soaking and washing procedure, i.e. polystyrene is dissolved by the DMC soaking/rinsing but the LiPON layer beneath remained intact.

1. A method of manufacturing an electrode-electrolyte laminate for use in a lithium-metal cell, comprising:
depositing a ceramic electrolyte layer onto a first surface of a sacrificial polymer substrate;
depositing a layer of lithium metal onto an exposed surface of the ceramic electrolyte layer to form a laminate precursor; and
removing the sacrificial polymer substrate from the laminate precursor to form the electrode-electrolyte laminate.

2. A method according to claim 1, further comprising depositing an encapsulation layer onto an exposed surface of the layer of lithium metal, after the deposition of the layer of lithium metal and before the removal of the sacrificial polymer substrate.

3. A method according to claim 1, wherein the sacrificial polymer substrate is removed by dissolving the sacrificial polymer substrate in a solvent.

4. A method according to claim 3, wherein the solvent comprises or consists of one or more linear or cyclic carbonate compounds.

5. A method according to claim 3, wherein the sacrificial polymer substrate is soaked in the solvent, followed by a step of rinsing to remove any residual sacrificial polymer substrate.

6. A method according to claim 1, wherein the ceramic electrolyte layer comprises or consists of one or more of LiPON, LAGP, LATP, LiSICON, perovskites and garnet ceramics.

7. A method according to claim 1, wherein the ceramic electrolyte layer has an amorphous structure.

8. A method according to claim 1, wherein the ceramic electrolyte layer is deposited onto the first surface of the sacrificial polymer substrate by a deposition process which involves the gradual deposition of atoms or molecules of the ceramic electrolyte onto the first surface of the sacrificial polymer substrate.

9. A method according to claim 1, wherein the layer of lithium metal is deposited onto the exposed surface of the ceramic electrolyte layer by a deposition process which involves the gradual deposition of lithium atoms onto the ceramic electrolyte layer.

10. A method according to claim 1, wherein vacuum conditions are utilized during the deposition of the ceramic electrolyte layer and the deposition of the lithium metal, and vacuum conditions are maintained between the deposition of the ceramic electrolyte layer and the deposition of the lithium metal.

11. A method according to claim 1, wherein the sacrificial polymer substrate comprises or consists of one or more sacrificial polymers independently selected from poly(vinylidene difluoride) (PVdF), poly(methyl methacrylate) (PMMA), poly(ethylene oxide) (PEO), poly-L-lactic acid (PLA) and polystyrene (PS).

12. (canceled)

13. A method according to claim 1, wherein the sacrificial polymer substrate has a thickness of from about 2 μm to about 100 μm.

14. A method according to claim 1, wherein after deposition the ceramic electrolyte layer has a thickness of from about 0.1 μm to about 4 μm.

15. A method according to claim 1, wherein after deposition the layer of lithium metal has a thickness of from about 0.01 μm to about 15 μm.

16. The method according to claim 1, further comprising placing the surface of the ceramic electrolyte layer which is exposed by removal of the sacrificial polymer substrate into contact with a cathode layer.

17. A method according to claim 16, wherein the cathode layer comprises a gel cathode or a solvent-cast cathode.

18. An electrode-electrolyte laminate for use in a lithium-metal cell, prepared by a method according to claim 1, comprising:
a ceramic electrolyte layer; and
a lithium metal layer on a first surface of the ceramic electrolyte layer.

19. The electrode-electrolyte laminate structure according to claim 18, comprising a cathode layer in contact with a second surface of the ceramic electrolyte layer.

20. The electrode-electrolyte laminate structure according to claim 19, wherein the cathode layer comprises a gel cathode or a solvent-cast cathode.

21. The electrode-electrolyte laminate structure according to claim 18, wherein the ceramic electrolyte layer comprises or consists of one or more of LiPON, LAGP, LATP, LiSICON, perovskites and garnet ceramics.

22. (canceled)

23. (canceled)

24. (canceled)
